(19) United States
(12) Patent Application Publication
(10) Pub. No.: US 2008/0198991 A1
(43) Pub. Date: Aug. 21, 2008

(54) Telephone and method of transmitting caller token

(75) Inventor: Mutsumi Saito, Fukuoka (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 12/008,018

(22) Filed: Jan. 8, 2008

(30) Foreign Application Priority Data
Feb. 21, 2007 (JP) 2007-040307

(51) Int. Cl. H04M 1/56

(52) U.S. Cl. 379/142.05

(57) ABSTRACT

The user token input unit accepts an input of a user token from a user. The user verifier reads a user reference from the user reference storage and verifies the user token on the basis of the user reference. When the verification of the user token is successful, the caller token embedder reads a caller token from a caller token storage and embeds the caller token in an audio signal. The caller token extractor extracts a caller token from a received audio signal. The caller verifier reads a caller reference from the caller reference storage and verifies the caller token on the basis of the caller reference. Verification output unit outputs the result of the verification.

### BACKGROUND OF THE INVENTION

1. Field of the Invention

The present invention relates to a telephone, and more particularly, to a method for confirming an identity of a caller.

2. Description of the Related Art

Frauds have committed frequently wherein a person who pretends to be a family member of a receiver calls the receiver and makes the receiver transfer cash to a specified account. In order to prevent such frauds, confirmation of the identity of the caller is necessary. One method for confirming the identity of the caller is utilizing caller ID (identification) service provided by telephone companies. That is, a caller is identified by confirming that the call is made from a telephone having a specific number as a caller ID. As disclosed in Japanese Unexamined Patent Application Publication No. 2003-233595, technologies for confirming a caller on the basis of audio information included in voices uttered by the caller has also been developed.

In a strict sense, confirmation using the caller ID does not guarantee that the identity of the caller is confirmed but guarantees only that the telephone used to make the call is confirmed. Accordingly, for example, when a criminal third party makes a call with a stolen mobile phone to a family member of the owner of the mobile phone, the family member cannot distinguish whether the caller is the owner of the mobile phone or the criminal third party. The accuracy of verification of a caller with audio information has limitations, and in particular, the accuracy of audio verification over telephones is low. Therefore, when the verification criteria are set to be loose, there is a risk that the criminal third party is mistaken for the owner of the mobile phone, while the verification criteria are set to be strict, there is a risk that the owner of the mobile phone cannot be recognized as the owner of the mobile phone.

### SUMMARY

It is an object of the present invention to provide a method for reliably confirming the identity of the caller.

According to an aspect of the present invention, there is provided a telephone which includes: a voice input unit which inputs an audio signal; a user token input unit which inputs a user token that is data for proving an identity of a user; a user reference storage which stores a user reference that is data used to verify the user token; a user verifier which verifies the user token on the basis of the user reference which is stored in the user reference storage; a caller token storage which stores a caller token that is data for proving an identity of a caller; and a caller token embedder which embeds, upon successful verification of the user token, in the audio signal the caller token which is stored in the caller token storage.

The user reference storage in the telephone may store a plurality of user references. The caller token storage may store caller tokens which correspond to each of the plurality of user references which are stored: in the user reference storage. In such a configuration, the caller token which corresponds to a user reference which is used in the successful verification of the user token is embedded in the audio signal.

According to another aspect of the present invention, there is provided a telephone which includes: a receiver which receives from a caller telephone an audio signal which is embedded with a caller token that is data for proving an identity of a caller; a caller token extractor which extracts the caller token from the audio signal; a caller reference storage which stores a caller reference that is data used to verify the caller token; and a caller verifier which verifies the caller token on the basis of the caller reference which is stored in the caller reference storage.

The caller reference may correspond to a telephone number. In such a configuration, a caller reference which corresponds to a telephone number which coincides with a caller ID which identifies the caller telephone is used for verifying the caller token.

According to another aspect of the present invention, there is provided a method for transmitting a caller token that is data for proving an identity of a caller. The method is executed by a telephone which includes a user reference storage which stores a user reference that is data used to verify a user token that is data for proving an identity of a user. The telephone further includes a caller token storage which stores the caller token. The method includes the steps of: accepting an input of an audio signal; accepting an input of the user token; verifying the user token on the basis of the user reference which is stored in the user reference storage; and embedding, upon successful verification of the user token, in the audio signal the caller token which is stored in the caller token storage.

According to another aspect of the present invention, there is provided a method for verifying a caller token that is data for proving an identity of a caller. The method is executed by a telephone which includes a caller reference storage which stores a caller reference that is data used to verify the caller token. The method includes the steps of receiving from a caller telephone an audio signal which is embedded with the caller token; extracting the caller token from the audio signal; and verifying the caller token on the basis of the caller reference which is stored in the caller reference storage.

According to another aspect of the present invention, there is provided a program storage medium which is readable by a computer and stores a program of instructions for the computer to execute a method for transmitting a caller token that is data for proving an identity of a caller, wherein the computer includes a user reference storage which stores a user reference that is data used to verify a user token that is data for proving an identity of a user, and the computer further includes a caller token storage which stores the caller token. The method includes the steps of: accepting an input of an audio signal; accepting an input of the user token; verifying the user token on the basis of the user reference which is stored in the user reference storage; and embedding, upon successful verification of the user token, in the audio signal the caller token which is stored in the caller token storage.

According to another aspect of the present invention, there is provided a program storage medium which is readable by a computer and stores a program of instructions for the computer for executing a method to verify a caller token that is data for proving an identity of a caller, wherein the computer includes a caller reference storage which stores a caller reference that is data used to verify the caller token. The method includes the steps of receiving from a caller telephone an audio signal which is embedded with the caller token; extracting the caller token from the audio signal; and verifying the caller token on the basis of the caller reference which is stored in the caller reference storage.

According to the present invention, user verification is performed in a caller telephone and a caller token proving the identity of the caller is transmitted to a receiver telephone only when the user verification is successful, while, in the receiver telephone, caller verification is performed with the caller token received from the caller telephone. Accordingly, the present invention may provide a method for transmitting a caller token with which the identity of the caller may be reliably confirmed by a receiver.

### BRIEF DESCRIPTION OF THE DRAWINGS

FIG. 1 is a diagram illustrating a system configuration of a telephone according to an embodiment of the present invention;

FIG. 2 is a flowchart illustrating a flow of a process of embedding a caller token performed in a caller telephone according to an embodiment of the present invention;

FIG. 3 is a flowchart illustrating a flow of a process of verifying a caller token performed in a receiver telephone according to an embodiment of the present invention;

FIG. 4 is a diagram illustrating an example of a process of embedding a caller token performed in a caller telephone according to an embodiment of the present invention;

FIG. 5 is a diagram illustrating an example of frequency characteristic of a notch filter;

FIG. 6 is a diagram illustrating an example of a voice spectrum;

FIG. 7 is a diagram illustrating an example of a voice spectrum which has been passed through a notch filter;

FIG. 8 is a diagram illustrating an example of a caller token;

FIG. 9 is a diagram illustrating an example of a conversion of a caller token to a sine wave;

FIG. 10 is a diagram illustrating an example of a voice spectrum of an audio signal in which a caller token is embedded;

FIG. 11 is a diagram illustrating an example of a process of extracting a caller token performed in a receiver telephone according to an embodiment of the present invention;

FIG. 12 is a diagram illustrating an example of frequency characteristic of a band-pass filter; and

FIG. 13 is a diagram illustrating an example of a computer environment.

### DESCRIPTION OF THE PREFERRED EMBODIMENTS

The Embodiments will be described with reference to the accompanying drawings.

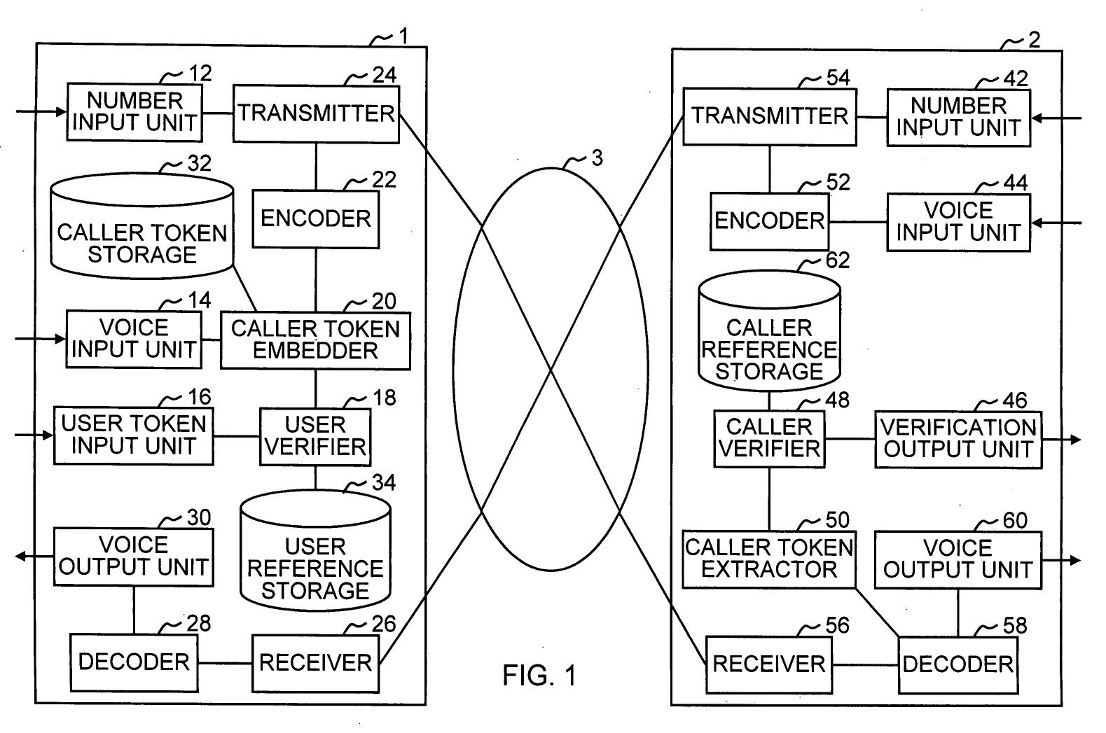

FIG. 1 is a diagram illustrating a system configuration of a telephone according to an embodiment of the present invention. A caller telephone 1 according to the present embodiment includes a number input unit 12 for specifying a telephone number of a receiver, a voice input unit 14 for inputting an audio signal, a user token input unit 16 for inputting a user token that is data proving an identity of a user as a valid user of the caller telephone 1, a user verifier 18 for verifying whether the user of the caller telephone 1 is a valid user on the basis of the inputted user token, a caller token embedder 20 for embedding in an audio signal a caller token that is data proving an identity of a caller as a valid caller, an encoder 22 for encoding the audio signal, a transmitter 24 for transmitting the telephone number and the encoded audio signal, a receiver 26 for receiving an encoded audio signal, a decoder 28 for decoding the received audio signal, a voice output unit 30 for outputting the decoded audio signal, a caller token storage 32 configured to store the caller token, and a user reference storage 34 configured to store a user reference that is data used to verify the user token.

A receiver telephone 2 according to the present embodiment includes a number input unit 42 for specifying a telephone number of a receiver, a voice input unit 44 for inputting an audio signal, an encoder 52 for encoding the audio signal, a transmitter 54 for transmitting the telephone number and the encoded audio signal, a receiver 56 for receiving an encoded audio signal, a decoder 58 for decoding the received audio signal, a voice output unit 60 for outputting the decoded audio signal, a caller token extractor 50 for extracting a caller token embedded in the decoded audio signal, a caller verifier 48 for verifying whether the user of the caller telephone is a valid caller on the basis of the extracted caller token, verification output unit 46 for outputting the verification result, and a caller reference storage 62 configured to store a caller reference that is data used to verify the caller token.

A process performed in the caller telephone 1 will be described. Only a process related to transmission of a caller token is described, while the description of a process related to a typical telephone call operation is omitted since the process is well known.

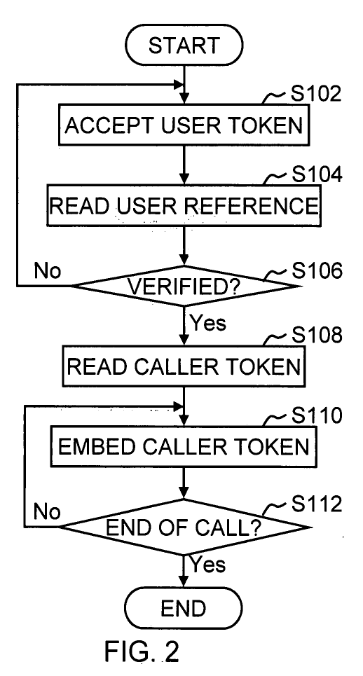

FIG. 2 is a flowchart illustrating a flow of a process of embedding a caller token performed in a caller telephone according to an embodiment of the present invention. The flow of the process of embedding a caller token performed in a caller telephone 1 according to the present embodiment will be described sequentially with reference to steps S102 to S112 shown in FIG. 2.

In step S102, the user token input unit 16 accepts an input of a user token from a user. In this embodiment, a four-digit password, for example, is used as the user token. However, the user token is not limited thereto and any information proving the user may be used. For example, biometric information such as a fingerprint or a vein pattern of a specific portion of a human body may be used as the user token.

In step S104, the user verifier 18 reads the user reference from the user reference storage 34. The user reference may be different for each receiver. In this case, the user reference is stored in the user reference storage 34 in correspondence with a telephone number of a respective receiver and the user verifier 18 reads the user reference corresponding to the telephone number of the receiver from the user reference storage 34. In the case where the user reference is different for each receiver, the user inputs a user token different for each user reference. When passwords are used as the user token, the passwords may be different for each receiver. When biometric information is used as the user token, the user token may be obtained from portions that are different for each receiver, for example, different fingers.

In step S106, the user verifier 18 verifies the user token on the basis of the user reference. In the description of the present embodiment, when the user token coincides with the user reference, the result of the verification is regarded as a success. However, the method of the verification is not limited to the above-described method and the result of the verification may be regarded as a success when the user token meets any criteria based on the user reference.

In step S108, when the verification of the user token is successful (Yes in step S106), the caller token embedder 20 reads the caller token from the caller token storage 32. A ten-digit decimal number is used as the caller token in this embodiment. However, the caller token is not limited thereto and any information proving the caller may be used. The caller token may be different for each receiver. In this case, the caller token is stored in the caller token storage 32 in correspondence with a telephone number of a respective receiver. The caller token embedder 20 reads the caller token corresponding to a telephone number of a receiver from the caller token storage 32. In this embodiment, it is assumed that the user token is different from the caller token. However, the user token may be used as the caller token.

The process in the steps described above may be performed at an arbitrary timing before the call is finished.

In step S110, the caller token embedder 20 embeds the caller token in an audio signal. The process in step S110 is performed after the call has started and is repeated until the call is finished (Yes in step S112). The audio signal may be an analog signal or a digital signal. In this embodiment, it is assumed that the audio signal is transmitted after being encoded. However, the audio signal is not necessarily processed only in the above-described manner and does not have to be encoded. When the audio signal is encoded, the process in step S110 is performed on the audio signal before encoded.

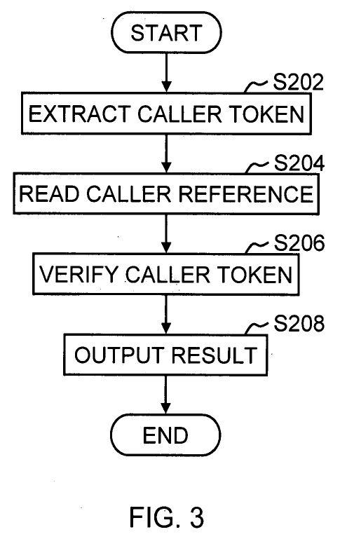

FIG. 3 is a flowchart illustrating a flow of a process of verifying a caller token performed in a receiver telephone according to an embodiment of the present invention. The flow of the process of verifying a caller token in the receiver telephone 2 according to the present embodiment will be described sequentially with reference to steps S202 to S208 shown in FIG. 3.

In step S202, the caller token extractor 50 extracts a caller token from a received audio signal. The process in step S202 is performed during a call. When the audio signal has been transmitted after being encoded, the process in step S202 is performed on the received audio signal after decoded.

In step S204, the caller verifier 48 reads the caller reference from the caller reference storage 62. The caller reference storage 62 may store caller references for a plurality of callers. In this embodiment, the caller reference is stored in the caller reference storage 62 in correspondence with a respective caller ID. The caller reference may also be stored in correspondence with information identifying a caller such as a name. The caller verifier 48 reads from the caller reference storage 62 the caller reference corresponding to a caller ID of the incoming call. Alternatively, the caller verifier 48 may read the caller reference corresponding to a caller specified by the receiver. A plurality of caller references may also be read without specifying a caller.

In step S206, the caller verifier 48 verifies the caller token on the basis of the caller reference. In the description of the present embodiment, when the caller token coincides with the caller reference, the result of the verification is regarded as a success. However, the method of the verification is not limited to the above-described method and the result of the verification may be regarded as a success when the caller token meets any criteria based on the caller reference. In the case where a plurality of caller references are read, the caller token is verified on the basis of each of the plurality of caller references.

In step S208, the verification output unit 46 outputs the result of the verification. Although any content may be used as the output, it is preferable to output information identifying the caller such as a caller ID or a name corresponding to the caller reference used in the verification when the verification is successful.

With the above-described configuration, user verification is performed in the caller telephone 1 and the caller token for proving the identity of the caller is transmitted to the receiver telephone 2 only when the user verification is successful, while, in the receiver telephone 2, caller verification is performed with the caller token received from the caller telephone 1.

Examples of a method of embedding a caller token in an audio signal performed in the caller telephone 1 and a method of extracting the caller token from the audio signal performed in the receiver telephone 2 will be described.

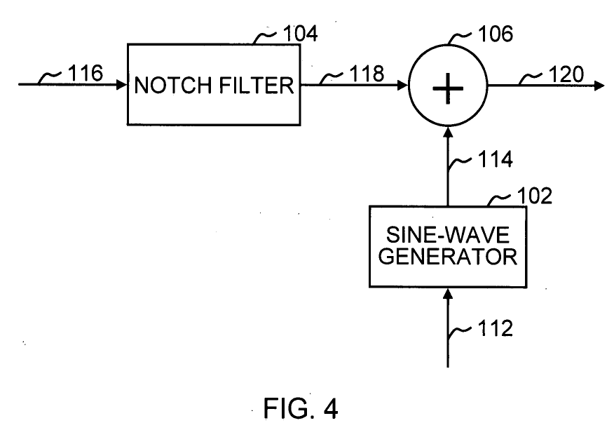

FIG. 4 is a diagram illustrating an example of a process of embedding a caller token performed in a caller telephone according to an embodiment of the present invention. An audio signal 116 to be transmitted from the caller telephone 1 to the receiver telephone 2 is passed through a notch filter 104 to remove specific frequency components from the audio signal 116. This yields an audio signal 118 not including the specific frequency components.

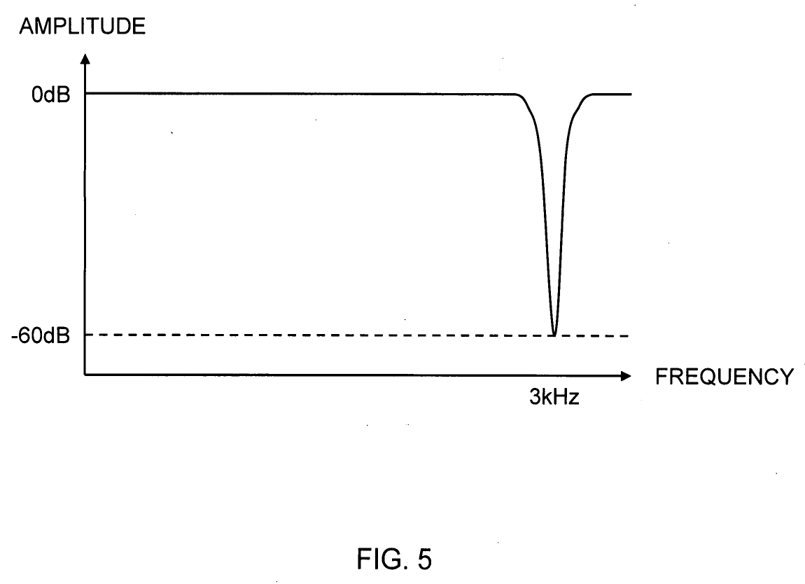

FIG. 5 is a diagram illustrating an example of frequency characteristic of a notch filter. In the example shown in FIG. 5, the center frequency of the notch filter 104 is 3 kHz. That is, when the notch filter 104 is used, frequency components around 3 kHz are removed from the audio signal 116. Although the center frequency of the notch filter 104 may be determined arbitrary, it is preferable to set the center frequency of the notch filter 104 to be between 300 Hz and 3400 Hz, which corresponds to the telephone-audio band. In this embodiment, the attenuation at the center frequency of the notch filter 104 is 60 dB. However, it is not limited thereto and may be determined arbitrary. The stopband bandwidth of the notch filter 104 may also be determined arbitrary.

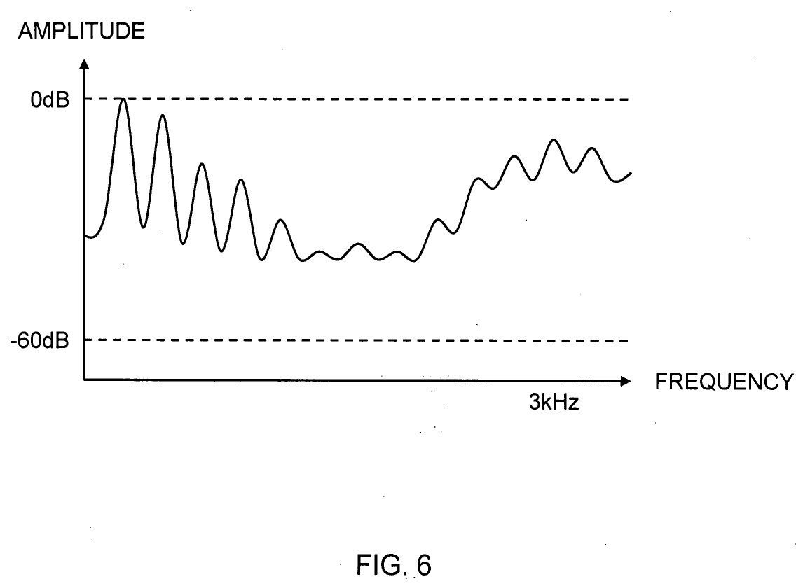

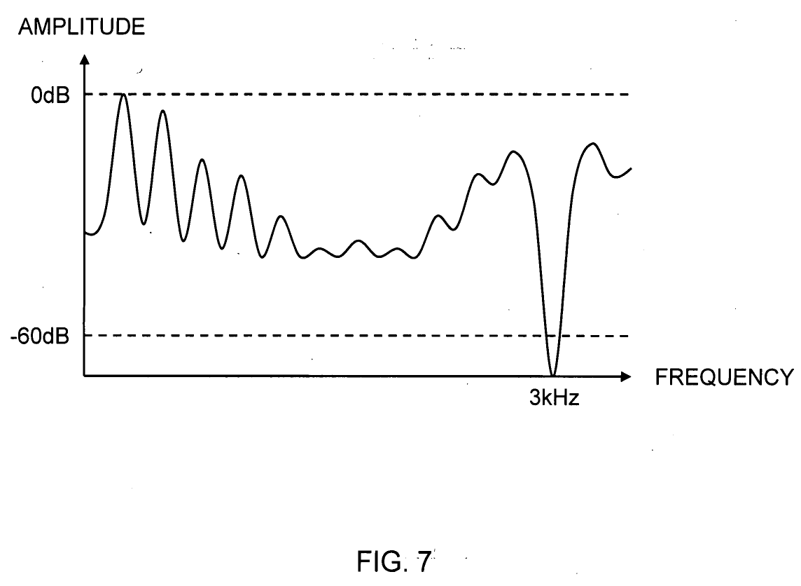

FIG. 6 is a diagram illustrating an example of a voice spectrum. FIG. 7 is a diagram illustrating an example of a voice spectrum which has been passed through a notch filter. In the example shown in FIG. 7, frequency components around 3 kHz are removed from an audio signal having the voice spectrum shown in FIG. 6 by applying the notch filter 104 having the frequency characteristic shown in FIG. 5.

In the present embodiment, a caller token is embedded as a sine wave in an audio signal. Referring to FIG. 4, sine-wave generator 102 generates a sine wave 114 on the basis of caller token 112, and then the sine wave 114 is embedded in an audio signal 118.

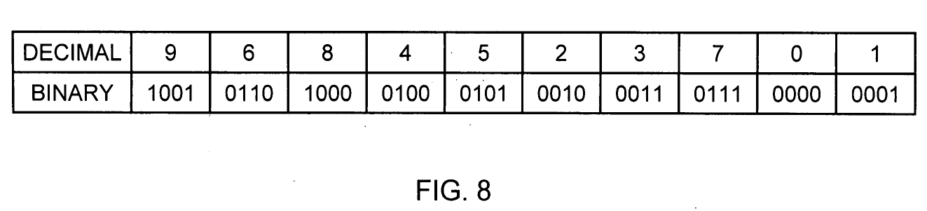

FIG. 8 is a diagram illustrating an example of a caller token. In the present embodiment, it is assumed that the caller token is a ten-digit decimal number. In the example shown in FIG. 8, “9684523701” is the caller token. Each digit of “9684523701” is converted to a binary number, whereby a forty-bit binary number is generated. The forty-bit binary number is converted to a sine wave, and then the sine wave is embedded in an audio signal.

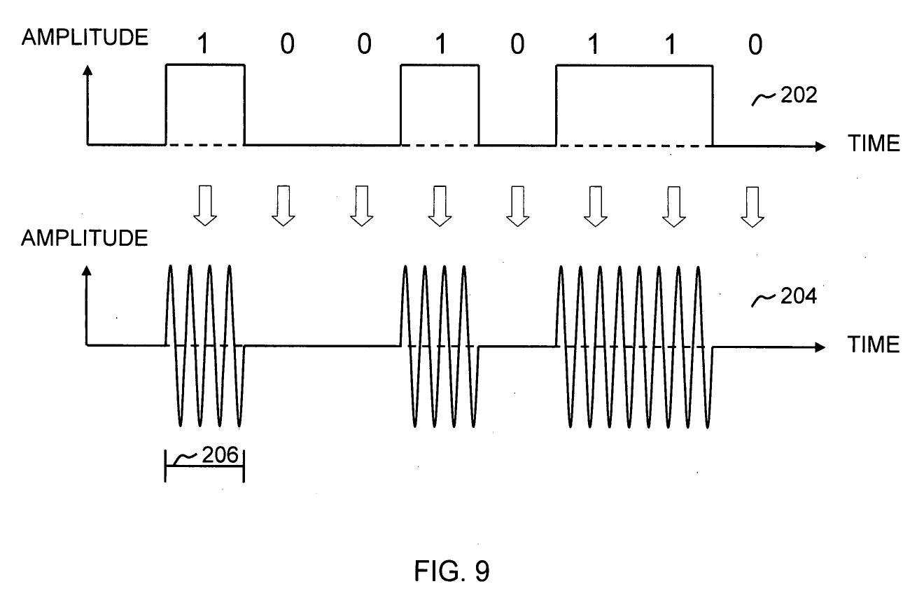

FIG. 9 is a diagram illustrating an example of a conversion of a caller token to a sine wave. FIG. 9 shows the first 8 bits of the forty-bit binary number corresponding to the caller token shown in FIG. 8. The forty-bit binary number shown in FIG. 8 is inputted as a rectangular wave 202 to the sine-wave generator 102. The sine-wave generator 102 outputs a sine wave 204 having a predetermined frequency only when the rectangular wave 202 is “1”. The frequency of the sine wave 204 is adjusted to be the center frequency of the notch filter 104. The pulse width 206 of the rectangular wave 202 may be determined arbitrary. For example, when the pulse width 206 of the rectangular wave 202 is 20 ms, 800 ms is required to transmit the forty-bit binary number. Furthermore, practically, a signal indicating the beginning of a caller token is added. For example, in the case of the decimal-to-binary conversion shown in FIG. 8, whatever the ten-digit decimal number is, the forty-bit binary number after the conversion does not include five or more consecutive “1's”. Accordingly, for example, “11111111” is added to the beginning of the forty-bit binary number to obtain a forty-eight-bit binary number, and the forty-eight-bit binary number is converted to a sine wave.

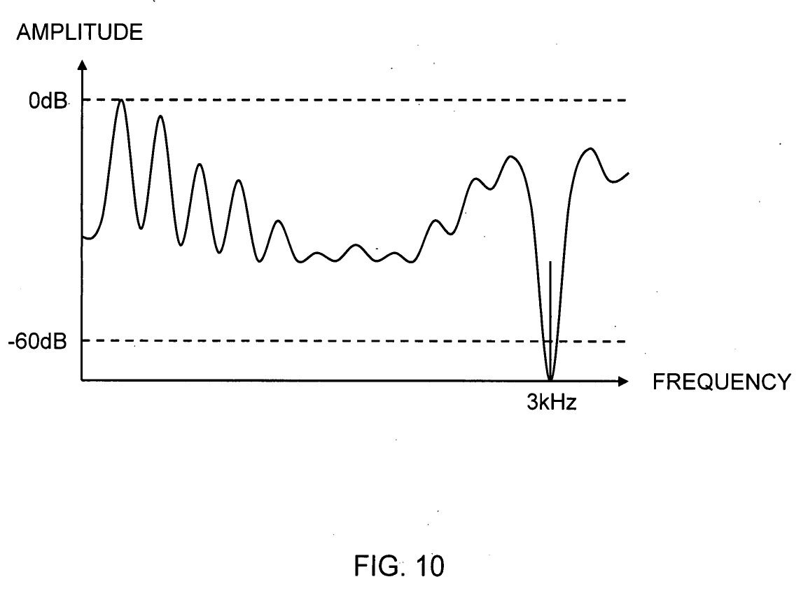

FIG. 10 is a diagram illustrating an example of a voice spectrum of an audio signal in which a caller token is embedded. Since a sine wave whose frequency is equivalent to the center frequency, i.e. 3 kHz, of the notch filter 104 is embedded in the audio signal, a line spectrum of 3 kHz appears in the example shown in FIG. 10.

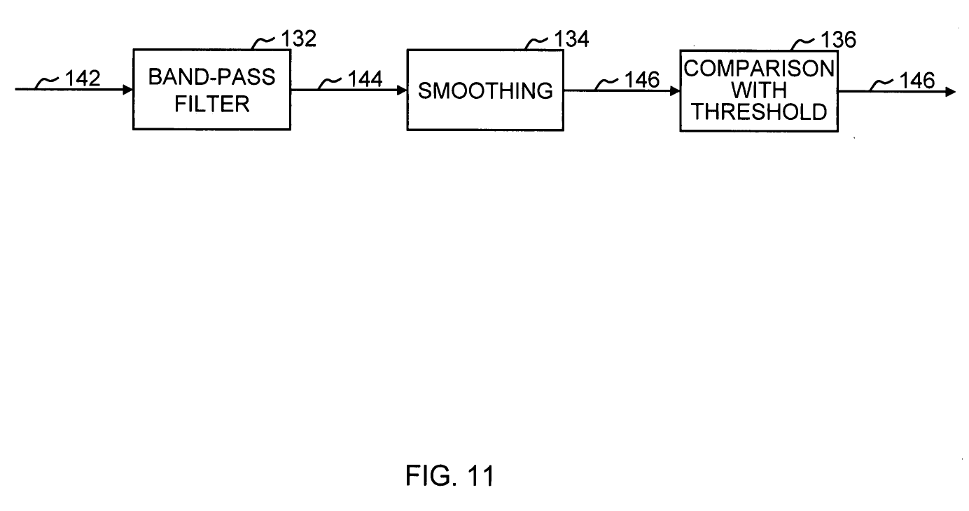

FIG. 11 is a diagram illustrating an example of a process of extracting a caller token performed in a receiver telephone according to an embodiment of the present invention. An audio signal 142 received by the receiver telephone 2 is passed through a band-pass filter 132.

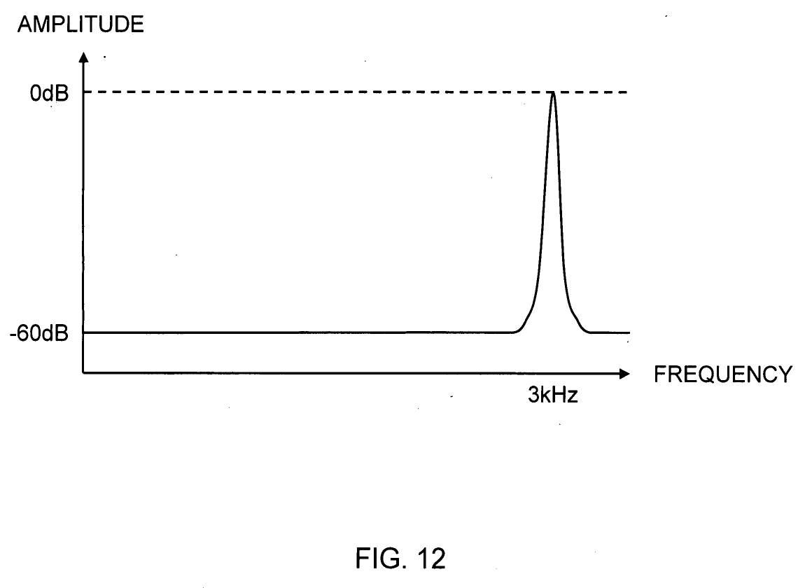

FIG. 12 is a diagram illustrating an example of frequency characteristic of a band-pass filter. The band-pass filter 132 has frequency characteristic of passing only frequency components around 3 kHz which is the center frequency of the notch filter 104 shown in FIG. 5. The audio signal 142 is passed through the band-pass filter 132 to obtain an audio signal 144 similar to the sine wave 204 shown in FIG. 9.

The audio signal 144 is smoothed and then compared with a predetermined threshold to obtain a rectangular wave 146. When the caller token extractor 50 detects a pulse having a pulse width of more than 100 ms (20 ms×5 bits) in the rectangular wave 146, the caller token extractor 50 recognizes that the caller token 112 begins at the end of the pulse and converts the following rectangular wave 146 to binary numbers. The caller token extractor 50 further converts the binary numbers, in units of four bits, to decimal numbers to restore the ten-digit decimal number.

As described above, in the present embodiment, user verification is performed in a caller telephone and a caller token proving the identity of the caller is transmitted to a receiver telephone only when the user verification is successful, while, in the receiver telephone, caller verification is performed with the caller token received from the caller telephone. Accordingly, the embodiments may provide a method for transmitting a caller token with which the identity of the caller may be reliably confirmed by a receiver. Since the caller token is embedded in the audio signal, there is no need to modify the protocol of telephone call.

Furthermore, the above-described functions in a telephone according to the present embodiment may be implemented not only as hardware but also as software in a computer built in a telephone. For example, when a program allowing a computer to perform the functions of the number input unit 12, the voice input unit 14, the user token input unit 16, the user verifier 18, the caller token embedder 20, the encoder 22, the transmitter 24, the receiver 26, the decoder 28, and the voice output unit 30 shown in FIG. 1 is generated, and when the program is loaded in a memory of the computer and executed, the above-described functions of a caller telephone may be implemented.

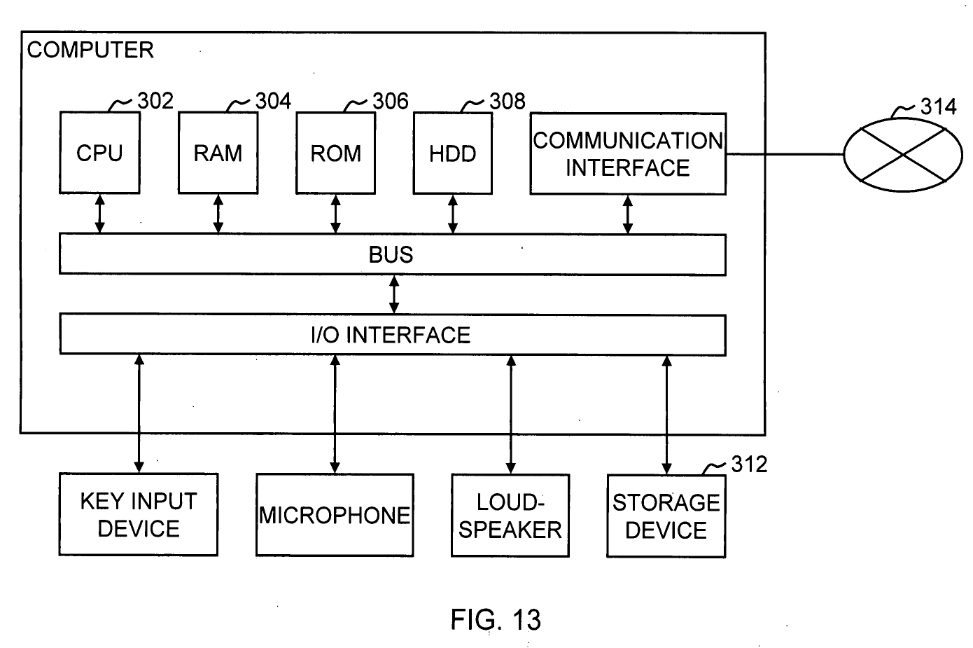

FIG. 13 is a block diagram showing an exemplary hardware configuration of a computer embedded in a telephone. A program for implementing the above-described functions of a telephone according to the present invention may be stored in any storage medium such as ROM (read-only memory) 306 or HDD (hard disk) 308. When the program is run, the program is loaded in RAM (random access memory) 304 and executed by CPU (central processing unit) 302. The program may be installed into HDD 308 from any portable recording medium 312 such as CD-ROM, DVD or USB memory or over communication network 314.

What is claimed is:

1. A telephone comprising:
a voice input unit for inputting an audio signal;
a user token input unit for inputting a user token that is data proving an identity of a user;
a user reference storage for storing a user reference that is data used to verify the user token;
a user verifier for verifying the user token on the basis of the user reference stored in the user reference storage;
a caller token storage for storing a caller token that is data proving an identity of a caller; and
a caller token embedder for embedding, upon successful verification of the user token, in the audio signal the caller token stored in the caller token storage.

2. The telephone of claim 1, wherein
said user reference storage stores a plurality of user references,
said caller token storage stores caller tokens corresponding to each of the plurality of user references stored in the user reference storage, and
a caller token corresponding to a user reference used in the successful verification of the user token is embedded in the audio signal.

3. A telephone comprising:
a receiver for receiving from a caller telephone an audio signal embedded with a caller token that is data proving an identity of a caller;
a caller token extractor for extracting the caller token from the audio signal;
a caller reference storage for storing a caller reference that is data used to verify the caller token; and
a caller verifier for verifying the caller token on the basis of the caller reference stored in the caller reference storage.

4. The telephone of claim 3, wherein
said caller reference corresponds to a telephone number, and
a caller reference corresponding to a telephone number coinciding with a caller ID identifying the caller telephone is used for verifying the caller token.

5. A method for transmitting a caller token that is data proving an identity of a caller, said method being executed by a telephone including a user reference storage for storing a user reference that is data used to verify a user token that is data proving an identity of a user, said telephone including a caller token storage for storing the caller token, said method comprising the steps of:
accepting an input of an audio signal;
accepting an input of the user token;
verifying the user token on the basis of the user reference stored in the user reference storage; and
embedding, upon successful verification of the user token, in the audio signal the caller token stored in the caller token storage.

6. The method of claim 5, wherein
said user reference storage stores a plurality of user references,
said caller token storage stores caller tokens corresponding to each of the plurality of user references stored in the user reference storage, and
a caller token corresponding to a user reference used in the successful verification of the user token is embedded in the audio signal

7. A method for verifying a caller token that is data proving an identity of a caller, said method being executed by a telephone including a caller reference storage for storing a caller reference that is data used to verify the caller token, said method comprising the steps of:
receiving from a caller telephone an audio signal embedded with the caller token;
extracting the caller token from the audio signal; and
verifying the caller token on the basis of the caller reference stored in the caller reference storage.

8. The method of claim 7, wherein
said caller reference corresponds to a telephone number, and
a caller reference corresponding to a telephone number coinciding with a caller ID identifying the caller telephone is used for verifying the caller token.

9. A program storage medium readable by a computer, said program storage medium storing a program of instructions for the computer for executing a method for transmitting a caller token that is data proving an identity of a caller, said computer including a user reference storage for storing a user reference that is data used to verify a user token that is data proving an identity of a user, said computer including a caller token storage for storing the caller token, said method comprising the steps of:
accepting an input of an audio signal;
accepting an input of the user token;
verifying the user token on the basis of the user reference stored in the user reference storage; and
embedding, upon successful verification of the user token, in the audio signal the caller token stored in the caller token storage.

10. The program storage medium of claim 9, wherein
said user reference storage stores a plurality of user references,
said caller token storage stores caller tokens corresponding to each of the plurality of user references stored in the user reference storage, and
a caller token corresponding to a user reference used in the successful verification of the user token is embedded in the audio signal

11. A program storage medium readable by a computer, said program storage medium storing a program of instructions for the computer for executing a method for verifying a caller token that is data proving an identity of a caller, said computer including a caller reference storage for storing a caller reference that is data used to verify the caller token, said method comprising the steps of:
receiving from a caller telephone an audio signal embedded with the caller token;
extracting the caller token from the audio signal; and
verifying the caller token on the basis of the caller reference stored in the caller reference storage.

12. The program storage medium of claim 11, wherein
said caller reference corresponds to a telephone number, and
a caller reference corresponding to a telephone number coinciding with a caller ID identifying the caller telephone is used for verifying the caller token.
